(19) United States
(12) Patent Application Publication
(10) Pub. No.: US 2024/0427843 A1
(43) Pub. Date: Dec. 26, 2024

(54) INFORMATION PROCESSING APPARATUS AND MEMORY SYSTEM

(71) Applicant: Kioxia Corporation, Tokyo (JP)

(72) Inventor: Atsushi KAWASUMI, Fujisawa Kanagawa (JP)

(73) Assignee: Kioxia Corporation, Tokyo (JP)

(21) Appl. No.: 18/743,892

(22) Filed: Jun. 14, 2024

(30) Foreign Application Priority Data
Jun. 22, 2023 (JP) 2023-102693

(51) Int. Cl. G06F 17/16

(52) U.S. Cl. CPC G06F 17/16

(57) ABSTRACT

An information processing apparatus configured to detect similarity between a first vector having a plurality of elements and a second vector having a plurality of elements based on an inner product value of the first vector and the second vector, the information processing apparatus has a wiring line having a current flowing therethrough, the current being a sum of currents each corresponding to a product of a value obtained by subtracting one of the elements of the first vector from a reference value and a corresponding one of the elements of the second vector, a sense amplifier configured to sense a voltage on the wiring line, and a similarity detection circuit configured to detect the similarity based on an output signal of the sense amplifier.

### CROSS REFERENCE TO RELATED APPLICATIONS

This application is based upon and claims the benefit of priority from the prior Japanese Patent Application No. 2023-102693, filed on Jun. 22, 2023, the entire contents of which are incorporated herein by reference.

### FIELD

Calculation of an inner product of vectors may be used for detecting similarity between the vectors. As the similarity between the vectors is higher, the inner product increases.

### BACKGROUND

Calculation of an inner product of vectors may be used for detecting similarity between the vectors. As the similarity between the vectors is higher, the inner product increases.

If the vectors have a number of elements, the inner product of the vectors can be calculated at a high speed using a hardware circuit. CIM (Computer In Memory) is known as an example of such a hardware circuit.

When the inner product of vectors is calculated by using a CIM to detect similarity between the vectors, for example, a circuit for detecting a greatest voltage value of a bit line, the signal level of which changes depending on the inner product, can be provided for easily detecting a pair of vectors having the greatest similarity.

However, a difference in voltage value of the bit line is slight between a case where vectors having the greatest inner product value are detected and a case where vectors having the second greatest inner product value are detected. Therefore, it is likely that variations occurring in manufacturing processes of semiconductor devices may cause erroneous detection of vectors having the greatest inner product value.

Embodiments of the present invention provide an information processing apparatus and a memory system for detecting similarity between vectors based on the inner product value of the vectors at a high speed and accuracy.

### BRIEF DESCRIPTION OF THE DRAWINGS

FIG. 1 is a schematic diagram of a CIM for calculating an inner product of vectors.

FIG. 2 is a circuit diagram showing an example of a configuration of a CIM for which a first vector and a second vector may be specified.

FIG. 3 is an equivalent circuit diagram of strings SR0 to SRm shown in FIG. 2.

FIG. 4 shows curved lines indicating relationships between an overdrive voltage and a drain-source current.

FIG. 5 shows ideal relationships between an overdrive voltage and a current flowing through a string.

FIG. 6 shows relationships between an overdrive voltage and a current flowing through a string, which are not ideal.

FIG. 7 is a CIM circuit diagram simplified from FIG. 2.

FIG. 8 shows an example of inner product values between a first vector and a second vector.

FIG. 9 shows a distribution of the inner product value between the first vector and the second vector shown in FIG. 8.

FIG. 10 shows the relationship between the time at which the inner product between the first vector and the second vector is calculated and the voltage level of a bit line BL.

FIG. 11 shows a time difference in detecting the similarity of the first vector and the second vector.

FIG. 12 is a circuit diagram of an information processing apparatus according to an embodiment.

FIG. 13 is a circuit diagram of an information processing apparatus according to a modification of the embodiment.

FIG. 14 is a block diagram schematically showing a configuration of a memory system according to an embodiment.

### DETAILED DESCRIPTION

In order to solve the aforementioned problem, an information processing apparatus is provided, the information processing apparatus being configured to detect similarity between a first vector having a plurality of elements and a second vector having a plurality of elements based on an inner product value of the first vector and the second vector, the information processing apparatus including:
a wiring line having a current flowing therethrough, the current being a sum of currents each corresponding to a product of a value obtained by subtracting one of the elements of the first vector from a reference value and a corresponding one of the elements of the second vector;
a sense amplifier configured to sense a voltage on the wiring line; and
a similarity detection circuit configured to detect the similarity based on an output signal of the sense amplifier.

Embodiments of an information processing apparatus and a memory system will be described below with reference to the accompanying drawings. Although main parts of the information processing device and the memory system will be mainly described below, the information processing apparatus and the memory system may include an element or a function that is not illustrated or described. The following descriptions do not exclude any element or function that is not illustrated or described.

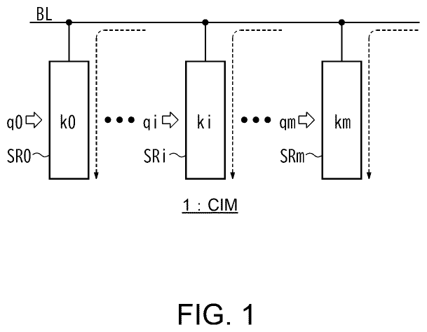

FIG. 1 is a schematic diagram of a CIM 1 for calculating the inner product between vectors. The CIM 1 includes one or more bit lines BL disposed in a memory cell array and a plurality of strings SR0 to SRm each having one end connected to the bit lines BL. Each of the strings SR0 to SRm includes a plurality of memory cell transistors connected in series. The memory cell transistor will be simply called “transistor” in the following descriptions. A different word line is connected to the gate of each transistor in a string. Although, in a general memory cell array, a plurality of word lines may be commonly connected to a plurality of strings SR0 to SRm, the word lines in the configuration of FIG. 1 are not necessarily connected commonly to the plurality of strings, and different word lines may be connected to each string.

The threshold voltage of the transistors in each string is set at a value depending on to a corresponding element of a first vector K (k0, k1, . . . , km) having (m+1) elements. The voltage level of one of the word lines connected to each string is set to conform to a corresponding element of a second vector Q (q0, q1, . . . , qm) having (m+1) elements. Here, m is an integer of 1 or more.

The string SR0 of the plurality of strings SR0 to SRm carries a current depending on the product of an element k0 of the first vector K and an element q0 of the second vector Q. The string Sri carries a current depending on the product of an element ki of the first vector K and an element qi of the second vector Q. The string SRm carries a current depending on a product of an element km of the first vector K and an element qm of the second vector Q.

The sum of the currents flowing through the strings SR0 to SRm is a current corresponding to the inner product value of the first vector K and the second vector Q. The current corresponding to the sum flows through the bit line BL. Therefore, the current flowing through the bit line BL changes depending on the inner product value of the first vector K and the second vector Q. As the inner product value increases, the sum of the currents flowing through the strings SR0 to SRm increases, i.e., the current flowing through the bit line BL increases, and the voltage level of the bit line BL considerably decreases.

It is possible to know the inner product value of the first vector K and the second vector Q by detecting the voltage level of the bit line BL, and therefore, the similarity between the first vector K and the second vector Q may be detected. However, the specifics of the first vector K and the second vector Q may not be determined. The reason for this is that there may be a plurality of combinations of the first vector K and the second vector Q having the same inner product value. In an embodiment described below, the circuit configuration including the strings of the CIM 1 is devised to determine the first vector K and the second vector Q.

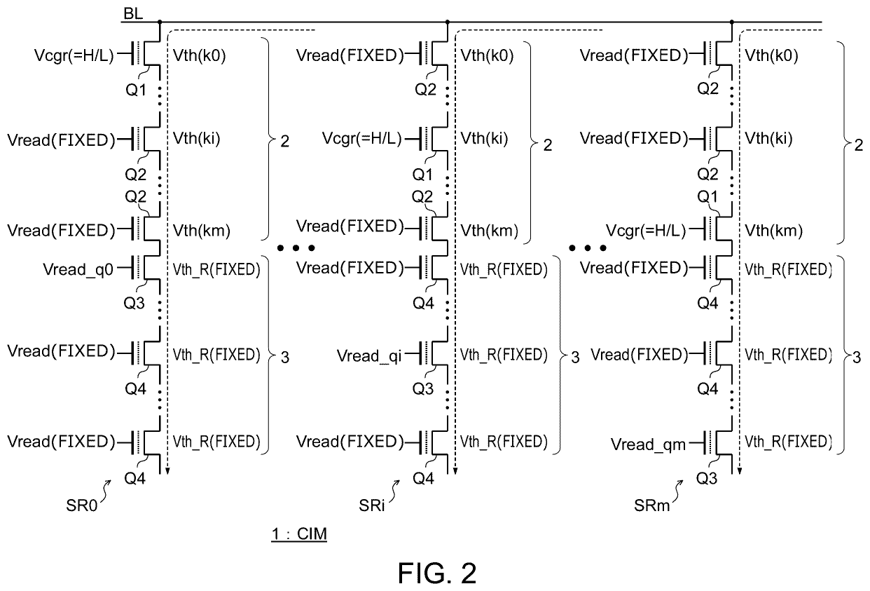

FIG. 2 is a circuit diagram showing an example of the configuration of a CIM 1 with which it may be possible to determine not only the similarity between the first vector K and the second vector Q but also the first vector K and the second vector Q themselves. The CIM 1 shown in FIG. 2 is a basic form of an information processing apparatus according to an embodiment, which will be described later. Each of strings SR0 to SRm shown in FIG. 2 includes a first transistor group 2 and a second transistor group 3 connected in series. The first transistor group 2 includes (m+1) transistors and is disposed on a side closer to the bit line BL than the second transistor group 3. The second transistor group 3 includes (m+1) transistors and is disposed on a side that is more distant from the bit line BL than the first transistor group 2.

The transistors in each string are, for example, NAND memory cell transistors that are capable of independently control the threshold voltage. In this embodiment, each element of the first vector K is stored by controlling the threshold voltage of each transistor in the first transistor group 2 of each string.

The threshold voltage of each of the transistors Q1 and Q2 in the first transistor group 2 is set so as to correspond to a corresponding element in the first vector K. A first fixed voltage (first voltage) Vcgr is applied to the gate of one transistor (first transistor) Q1 included in the (m+1) transistors in the first transistor group 2, and a second fixed voltage (second voltage) Vread is applied to the gate of each of the remaining m transistors Q2. The voltage level of the second fixed voltage Vread is higher than that of the first fixed voltage Vcgr. In the first transistor group 2 in each of the strings SR0 to SRm, the position of the transistor Q1, to the gate of which the first fixed voltage Vcgr is applied, is different. For example, in the string SR0, the first fixed voltage Vcgr is applied to the gate of the transistor Q1 having a threshold voltage corresponding to an element k0 in the first transistor group 2, and the second fixed voltage Vread is applied to the gate of each of the remaining transistors Q2. Similarly, in the string SRi, the first fixed voltage Vcgr is applied to the gate of the transistor Q1 having a threshold voltage corresponding to an element ki in the first transistor group 2, and the second fixed voltage Vread is applied to the gate of each of the remaining transistors Q2. In the string SRm, the first fixed voltage Vcgr is applied to the gate of the transistor Q1 having a threshold voltage corresponding to an element km in the first transistor group 2, and the second fixed voltage Vread is applied to the gate of each of the remaining transistors Q2.

The first fixed voltage Vcgr is higher than the threshold voltages that may be set at the transistors Q1 and Q2 in the first transistor group 2. The difference in voltage between the first fixed voltage Vcgr and the threshold voltage of the transistor Q1 is called “overdrive voltage” herein. A current corresponding to the overdrive voltage flows between the drain and the source of the transistor Q1 to the gate of which the first fixed voltage Vcgr is applied. As the overdrive voltage increases, the current flowing between the drain and the source (drain-source current) of the transistor Q1 increases.

The second fixed voltage Vread has a voltage level sufficient to turn on the m transistors Q2 at each gate of which the second fixed voltage Vread is applied.

In the (m+1) transistors Q1 and Q2 in the first transistor group 2, the m transistors Q2 are in the ON state. Therefore, a current corresponding to the overdrive voltage flows through the first transistor group 2, the overdrive voltage being a difference in voltage between the first fixed voltage Vcgr and the threshold voltage of the transistor Q1, to the gate of which the first fixed voltage Vcgr is applied. In the (m+1) transistors Q1 and Q2, the transistor Q1, to the gate of which the first fixed voltage Vcgr is applied, operates in the sub-threshold region, and the remaining m transistors Q2 operate in the saturation region.

A common threshold voltage Vth_R is set for the (m+1) transistors Q3 and Q4 in the second transistor group 3. A voltage depending on a corresponding element in the second vector Q is applied to the gate of one transistor (second transistor) Q3 in the (m+1) transistors Q3 and Q4. The second fixed voltage Vread is applied to the gate of each of the remaining m transistors Q4. Therefore, the m transistors Q4 are in the ON state. The position of the transistor Q3, to the gate of which a voltage corresponding to a corresponding element in the second vector Q is applied, differs in each string, but the m transistors other than the transistor Q3 are in the ON state in each string.

The current flowing through the second transistor group 3 depends on the drain-source current of the transistor Q3 to the gate of which a voltage depending on a corresponding element in the second vector Q is applied. Since the second fixed voltage Vread is applied to the gate of each of the remaining m transistors Q4, the m transistors Q4 operate in the saturation region.

The current I flowing through the strings SR0 to SRm is expressed by the following equation (1):

$$I = a \times ( Kb \times Qc ) \qquad ( 1 )$$

In the equation (1), “a” denotes a proportionality coefficient, “Kb” denotes the corresponding element in the first vector K for setting the threshold voltage of the first transistor Q1, to the gate of which the first voltage Vcgr is applied, in the first transistor group 2, and “Qc” is the corresponding element in the second vector Q for setting a voltage applied to the gate of the second transistor Q3 in the second transistor group 3.

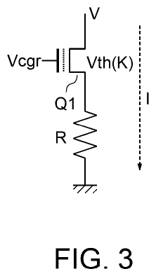

FIG. 3 is an equivalent circuit diagram of each of the strings SR0 to SRm shown in FIG. 2. In FIG. 3, the first transistor group 2 is indicated by a first transistor Q1, and the second transistor group 3 is indicated by a resistance R. The first transistor Q1 shown in FIG. 3 is the same as the first transistor Q1, to the gate of which the first voltage Vcgr is applied, in the transistors of the first transistor group 2. Since the transistors Q2 other than the first transistor Q1, to the gate of each of which the first voltage Vcgr is applied, in the first transistor group 2 are set in the ON state, they may be omitted when the circuit operation is considered.

The resistance R shown in FIG. 3 has a resistance value that is the sum of the resistance values between the source and drain of one or more second transistors Q3 in the second transistor group 3. Each second transistor Q3 in the second transistor group 3 has a resistance between drain and source (drain-source resistance) that depends on a difference in voltage between the threshold voltage and the gate voltage Vread_qi depending on a corresponding element in the second vector Q applied to the gate of the second transistor Q3. Therefore, in total, the second transistor group 3 has a resistance value corresponding to the sum of drain-source resistance values of the second transistors Q3 in the second transistor group 3.

As described above, it is assumed that in this embodiment, the first transistor Q1, to the gate of which the first voltage Vcgr is applied, in the first transistor group 2 operates in the sub-threshold region, and the one or more transistors Q2, to the gate(s) of which the second voltage Vread is applied operate in the saturation region. The sub-threshold region may also be called a linear region, in which the drain-source current changes linearly relative to the gate voltage.

In this embodiment, the electric potential of the bit line BL is changed by causing currents depending on the products of elements of the first vector K and the second vector Q to flow through the strings SR0 to SRm. If the threshold voltage and the gate voltage of each transistor in the strings SR0 to SRm change, the currents flowing through the strings SR0 to SRm also change, resulting in that the electric potential of the bit line BL may change. In this embodiment, it is intended that the change in the currents flowing through the strings SR0 to SRm is as little as possible when the products of the elements in the first vector K and the second vector Q for the strings SR0 to SRm are calculated.

Since the transistor shown in FIG. 3 operates in the sub-threshold region, the current I flowing between the drain and the source (drain-source current) may be expressed in the transistor model formula expressed by the following equation (2):

$$I = {I}_{o} {10}^{\frac{{V}_{gs} - {V}_{th}}{{S}_{g}} + \frac{{V}_{ds}}{{S}_{d}}} + ( 1 - {e}^{- \frac{{V}_{ds}}{{V}_{th}}} ) \qquad ( 2 )$$

In the equation (2), “Vgs” denotes the voltage between the gate and source (gate-source voltage) of the transistor, “Vds” denotes the voltage between the drain and the source (drain-source voltage) of the transistor, “Vth” denotes the threshold voltage of the transistor, “Sg” denotes the sub-threshold swing parameter, “Sd” denotes the drain-induced barrier lowering parameter, and “Io” denotes the constant of proportionality determined by the gate length L, the gate width, the mobility, and the like of each transistor in the string.

If the equation (2) is logarithmically transformed with the second term of the right side being ignored and the voltage drop caused by the current I at the resistance R shown in FIG. 3 being considered, the following equation (3) can be obtained.

$$ln ( I ) + a \times I = b \times ( Vg - Vth ) + c \qquad ( 3 )$$

In the equation (3), “Vg” denotes the gate potential of the transistor. The following equations (4), (5), and (6) express “a,” “b,” and “c” in the equation (3). In the equation (4), “Rb” denotes the resistance R in FIG. 3. In the equation (6), “V” denotes the drain voltage of the first transistor Q1 shown in FIG. 3.

$$a = \frac{{R}_{b}}{{S}_{g}} \times ln 10 \qquad ( 4 )$$

$$b = \frac{ln 10}{{S}_{g}} \qquad ( 5 )$$

$$c = \frac{V \cdot ln 10}{{S}_{d}} + ln {I}_{o} \qquad ( 6 )$$

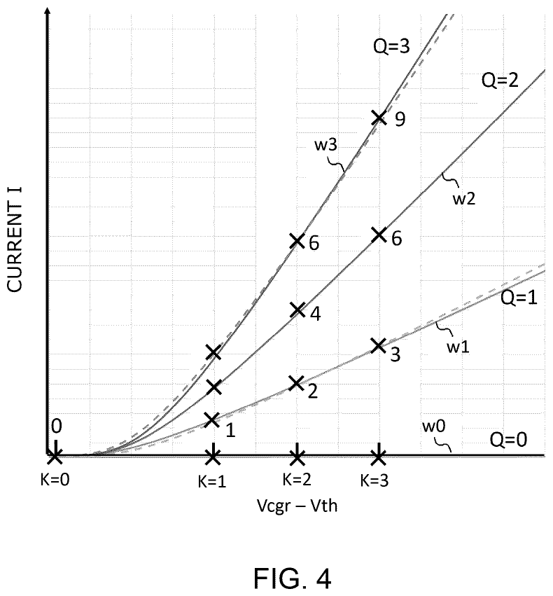

FIG. 4 shows curved lines each indicating the relationship between the overdrive voltage and the drain-source current of the transistor Q1, to the gate of which the first fixed voltage Vcgr is applied, in the first transistor group 2. The horizontal axis in FIG. 4 indicates the overdrive voltage, and the vertical axis indicates the drain-source current of the transistor Q1. Each solid curved line in FIG. 4 shows a simulation waveform, and each broken curved line shows a waveform obtained when a fluctuation of the threshold voltage or the gate voltage occurs in a transistor Q1, Q2, Q3m or Q4 in the strings SR0 to SRm.

FIG. 4 shows a line w0 in a case where the voltage (Q) depending on the corresponding element in the second vector Q in the second transistor group 3 is zero (Q=0), a curved line w1 in a case where Q=1, a curved line w2 where Q=2, and a curved line w3 where Q=3. If the voltage Q depending on the corresponding element of the second vector Q changes, the resistance value of the second transistor group 3 changes, which makes the curved lines indicating the relationship between the overdrive voltage and the drain-source current of the transistor Q1 different.

The points marked by “x” in FIG. 4 represent plot positions of the drain-source current of the transistor Q1 when a predetermined overdrive voltage is given. If the threshold voltage and the gate voltage in each of the transistors Q1 to Q4 in the strings SR0 to SRm change, the currents flowing through the strings SR0 to SRm change, and the shapes of the waveforms of the curved lines w1 to w3 in FIG. 4 also change. In order to correctly detect the result of the calculation of inner product by monitoring the electric potential of the bit line BL even if the waveforms of the curved lines w1 to w3 change, it is preferable that the overdrive voltage be plotted in a region that is close to linear of the waveforms of the curved lines w1 to w3.

In the example of FIG. 4, all of the plot positions of the overdrive voltage are in the linear regions of the waveforms of the curved lines w1 to w3. Therefore, the intervals between adjacent plots are substantially the same. This makes it possible to correctly determine the overdrive voltage from the currents flowing through the string SR0-SRm. This means that the first vector K and the second vector Q may be determined from the currents flowing through the strings SR0 to SRm.

The waveforms of the curved lines w1 to w3 shown in FIG. 4 may be changed by adjusting the resistance value in the second transistor group 3 in the strings SR0 to SRm. The resistance value of the second transistor group 3 may be adjusted by adjusting the threshold voltage of each transistor Q3. The change in threshold voltage of each transistor Q3 enables the adjustment of the waveforms of the curved lines w1 to w3 so as to increase their linear regions.

The voltage level of the overdrive voltage may be changed by adjusting the voltage level of the first voltage Vcgr applied to the gate of the transistor Q1 in the first transistor group 2. Therefore, by adjusting the first voltage Vcgr, the plot positions of the overdrive voltage may be set to be within the linear regions of the curved lines w1 to w3.

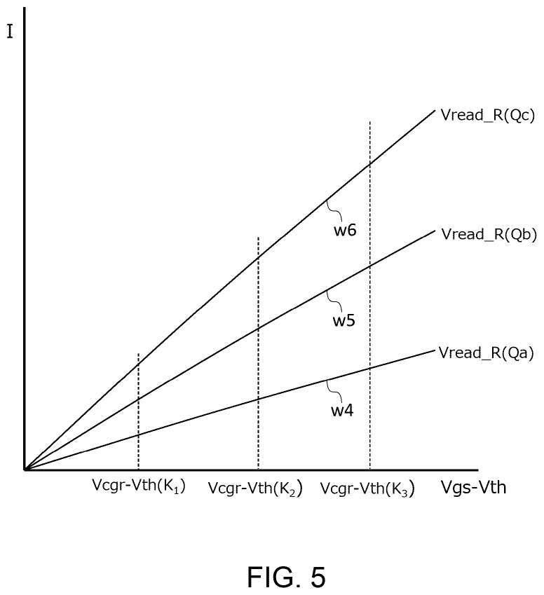

FIG. 5 shows ideal relationships between the overdrive voltage applied to a specific transistor Q1 in the first transistor group 2 in the strings SR0 to SRm and the currents flowing through the strings SR0 to SRm. The horizontal axis in FIG. 5 represents the overdrive voltage (Vcgr-Vth) applied to the gate of the transistor Q1, and the vertical axis represents the current flowing through the strings SR0 to SRm. FIG. 5 shows three linear lines w4 to w6 obtained by changing data of the second vector Q corresponding to the voltage applied to the gate of the transistor Q3 in the second transistor group 3 of the strings SR0 to SRm in three ways. In FIG. 5, the three data items of the second vector Q are denoted by “Qa,” “Qb,” and “Qc.”

If the currents flowing through the strings SR0 to SRm linearly change relative to a change in overdrive voltage as shown in FIG. 5, the intervals between plot positions of the current flowing through the strings SR0 to SRm, corresponding to the overdrive voltage, become constant. As a result, if the current flowing through the strings SR0 to SRm may fluctuate, the first vector K and the corresponding second vector Q may be determined.

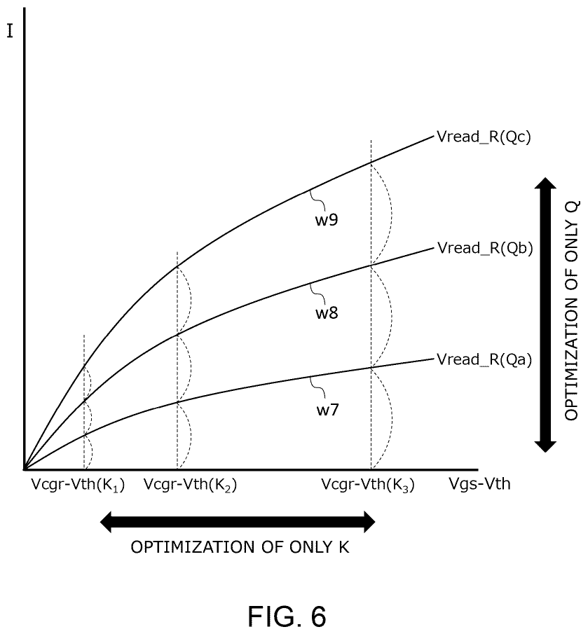

FIG. 6 shows the relationships between the overdrive voltage and the strings SR0 to SRm, the relationships not being ideal. What are indicated by the horizontal axis and the vertical axis of FIG. 6 are the same as those of FIG. 5. FIG. 6 shows three curved lines w7 to w9 obtained by changing the data of the second vector Q corresponding to the voltage applied to the gate of the transistor Q3 of the second transistor group 3 of the strings SR0 to SRm in three ways. The three data items of the second vector Q are indicated by Qa, Qb, and Qc in FIG. 6.

The waveforms of the curved lines w7 to w9 may be changed by adjusting the threshold voltage of the transistor Q3 in the second transistor group 3. The overdrive voltage may be changed by adjusting the first voltage Vcgr applied to the gate of the transistor Q1 in the first transistor group 2. As a result of the adjustment, the plot positions of the overdrive voltage may be disposed with constant intervals on the curved lines w7 to w9 as shown in FIG. 6. Therefore, if the current flowing through the strings SR0 to SRm fluctuates to some extent, the first vector K and the second vector Q relating thereto may be determined.

As described above, the first transistor group 2 and the second transistor group 3 are connected in series in each string connected to the bit line BL, a threshold voltage corresponding to a corresponding element of the first vector K is set at each transistor of the first transistor group 2, and an overdrive voltage is applied to the gate of one of the transistors. A voltage corresponding to a corresponding element of the second vector Q is applied to the gate of one of the transistors in the second transistor group 3 of each string. As a result, each string carries a current depending on a multiplication of corresponding elements in the first vector K and the second vector Q, and the bit line carries a current corresponding to the sum of currents flowing through the respective strings. The inner product value of the first vector K and the second vector Q may be obtained by detecting the current or the voltage of the bit line, and the first vector K and the second vector Q may be determined from the current flowing through each of the strings.

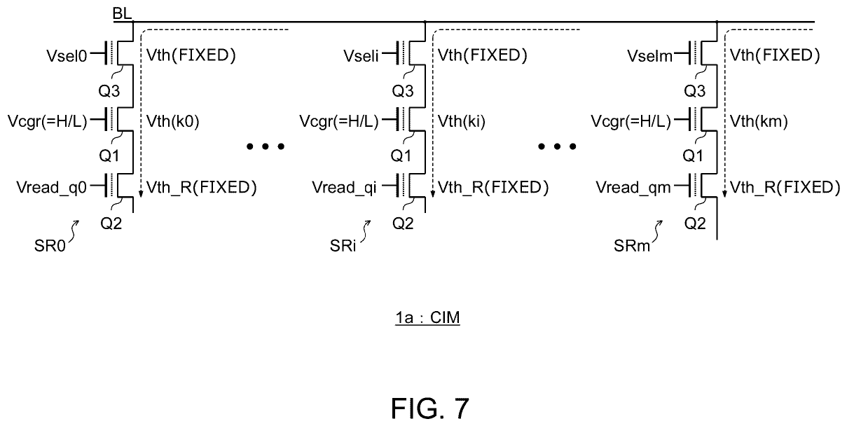

The configuration of the CIM 1 shown in FIG. 2 may be more simplified. FIG. 7 is a circuit diagram of a CIM 1a obtained by simplifying the circuit diagram of FIG. 2. In FIG. 7, each of the strings SR0 to SRm includes at least three transistors Q1 to Q3 that are connected in series.

The threshold voltages Vth(k0), . . . , Vth(ki), . . . , Vth(km) corresponding to elements of the first vector K are set at the first transistors Q1 of the respective strings. The first fixed voltage (first voltage) Vcgr is applied to the gates of all the first transistors Q1. Since the common first voltage Vcgr is applied to the gates of the first transistors Q1, the first voltage Vcgr may be applied by a word line (not shown) that is connected to cross the strings SR0 to SRm. Each of the first transistors Q1 can carry a current depending on a difference in voltage between the first voltage Vcgr and the threshold voltage Vth(ki) (i=0, . . . , m).

Voltages (second voltage) Vread_q0, . . . , Vread_qi, . . . , Vread_qm corresponding to elements of the second vector Q is applied to the gates of the second transistors Q2 of the respective strings. A predetermined threshold voltage Vth_R is commonly set at all the second transistors Q2. Each of the second transistors Q2 can carry a current corresponding to a difference in voltage between the second voltage Vread_qi (i=0, . . . , 7) and the threshold voltage Vth_R¥.

The third transistor Q3 of each string functions as a selection transistor for selecting the corresponding string. A selection signal Vsel0, . . . , Vseli, . . . , or Vselm is applied to the gate of each third transistor Q3. A common threshold voltage Vth is set for all the third transistors Q3. When at least one of the selection signals Vsel0 to Vselm is caused to have a high-level voltage, the corresponding third transistor Q3 is turned on and the corresponding string is selected. For example, a threshold voltage is set independently at the first transistor Q1 by this selection. If all the selection signals Vsel0 to Vselm are caused to have the high-level voltage at the same time, all the strings SR0 to SRm are selected at the same time. As a result of such a simultaneous selection, for example, a current corresponding to the sum of the currents flowing through the strings SR0 to SRm flows through the bit line, as will be described later. In the CIM 1a shown in FIG. 7, the third transistors Q3 are not indispensable. If a different word line is connected to the gate of each of the first transistors Q1, the third transistors Q3 may be omitted.

In FIG. 7, the third transistor Q3, the first transistor Q1, and the second transistor Q2 are sequentially connected in series in this order from the side close to the bit line in each of the strings SR0 to SRm. However, the order of connection of the first to third transistors Q1 to Q3 in each of the strings SR0 to SRm may be arbitrarily determined. If necessary, a selection transistor may also be connected to the side of the second transistor Q2 that is more distant from the bit line.

The calculation of the inner product of the first vector K and the second vector Q may be performed by the CIM 1a shown in FIG. 7. Each of the strings SR0 to SRm carries a current depending on the product of corresponding elements of the first vector K and the second vector Q. Therefore, a current corresponding to the sum of the currents flowing through the respective strings SR0 to SRm flows through the bit line, and the potential of the bit line decreases depending on the sum of the currents. The current flowing through the bit line and the potential of the bit line have values corresponding to the inner product value of the first vector K and the second vector Q.

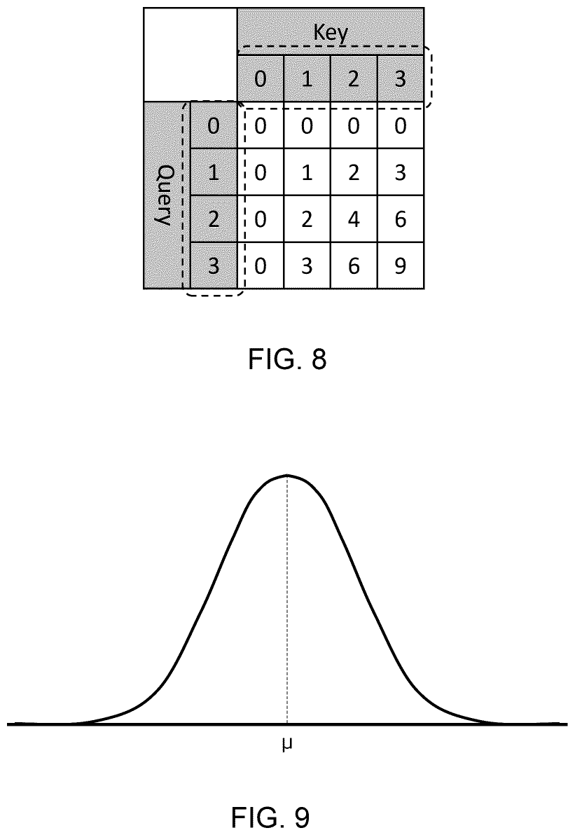

FIG. 8 is a diagram showing an example of inner product value of the first vector K and the second vector Q. In FIG. 8, the first vector K is called “Key” and the second vector Q is called “Query.” In the example of FIG. 8, each element of the first vector K may have values 0, 1, 2, and 3, and each element of the second vector Q may have values 0, 1, 2, and 3. In this case, the inner product value is one of 0, 1, 2, 3, 4, 6, and 9.

FIG. 9 shows a distribution of the inner product value of the first vector K and the second vector Q of FIG. 8. The horizontal axis of FIG. 9 represents the inner product value and the vertical axis represents the frequency. The mean value μ of the inner product value shown in FIG. 8 is 2.25. The frequency at which the inner product value is the mean value μ is the greatest, and therefore the frequency distribution of the inner product value is a normal distribution as shown in FIG. 9. As may be understood from FIG. 9, the frequency at which the inner product value is the largest is the same as the frequency at which the inner product value is the smallest. Generally, the similarity between the first vector K and the second vector Q is determined by a condition with which the inner product value becomes the greatest. However, in the embodiment, for the reason described later, the similarity of the first vector K and the second vector Q is determined by a condition with which the inner product value becomes the smallest.

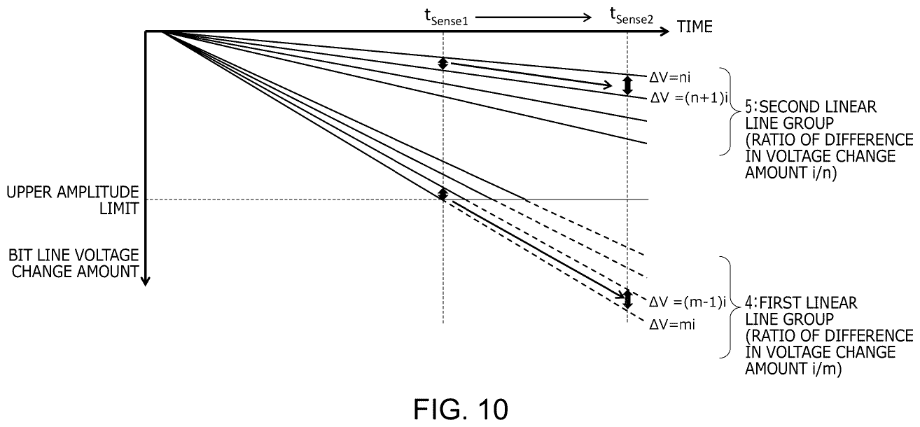

FIG. 10 shows the relationship between the time when the inner product of the first vector K and the second vector Q is calculated by the information processing apparatus shown in FIG. 2 and the voltage level of the bit line BL. The horizontal axis in FIG. 10 represents time and the vertical axis represents the voltage change amount of the bit line BL. FIG. 10 shows a linear line group (“first linear line group”) 4 for which the current flowing through the bit line BL is the greatest or near the greatest and a linear line group (“second linear line group”) 5 for which the current flowing through the bit line BL is the smallest or near the smallest. The voltage of the bit line BL decreases more as the current flowing through the bit line BL increases more. In FIG. 10, the direction in which the voltage of the bit line BL decreases (the downward direction in FIG. 10) is the positive direction. The first linear line group 4 indicates the voltage level of the bit line BL at the right tail of the normal distribution curve shown in FIG. 9 where the inner product value is greater than the mean value and the frequency is near zero. The second linear line group 5 indicates the voltage level of the bit line BL at the left tail of the normal distribution curve shown in FIG. 9 where the inner product value is smaller than the mean value and the frequency is near zero.

If the voltage change amount corresponding to the largest current flowing through the bit line BL in the linear lines included in the first linear line group 4 is expressed as ΔV=mi, the voltage change amount corresponding to the second largest current is expressed as ΔV=(m−1)i, where “m” denotes the gradient of the change in time of the voltage change amount ΔV corresponding to the largest current flowing through the bit line BL (the amount of change in the voltage change amount ΔV per unit time), and “i” denotes time. The difference in voltage change amount between two bit lines BL in which the values of currents flowing therethrough differ by one level is “i.” As the time passes, the difference in voltage change amount increases. The ratio of time difference in voltage change amount between the two bit lines BL, for which the current value differs by one level is i/m, which increases as “m” decreases or time “i” increases (lapses).

If the voltage change amount corresponding to the largest current flowing through the bit line BL in the linear lines included in the second linear line group 5 is expressed as ΔV=ni, the voltage change amount corresponding to the second largest current is expressed as ΔV=(n+1)i, where “n” denotes the gradient of the change in time of the voltage change amount ΔV corresponding to the smallest current flowing through the bit line BL (the amount of change in the voltage change amount ΔV per unit time), and “i” denotes a difference in voltage change amount between two bit lines BL in which the values of currents flowing therethrough differ by one level, and “i/n” denotes the ratio of time difference in voltage change amount. The ratio “i/n” increases as “n” decreases or time “i” increases (lapses). As shown in FIG. 10, as the current flowing through the bit line BL decreases, the voltage change amount of the bit line BL relative to the time difference decreases (n<m). As the voltage change amount of the bit line BL decreases, the ratio of time difference in voltage change amount increases (i/n>i/m).

As described above, the difference in voltage change amount between two bit lines BL for which the values of currents flowing therethrough differ by one level is “i” for both the case where the current flowing through the bit line BL is near the greatest value and the case where the current is near the smallest value, the difference increases as the time lapses. Since “m” is larger than “n,” as the current flowing through the bit line BL decreases, the ratio of time difference in voltage change amount increases. The increase in the ratio of time difference in voltage change amount means an increase in time difference between the bit lines BL to reach a predetermined voltage. Therefore, erroneous detections of bit line BL may be reduced.

The voltage amplitude of the bit line BL is limited. Since the change in voltage level of the bit line BL of the first linear line group 4 is greater than that of the second linear line group 5, it is more likely that the voltage amplitude of the voltage level of the first linear line group 4 reaches the upper limit (the lower limit voltage of the bit line). In order to detect the similarity between the first vector K and the second vector Q with the first linear line group 4, the detection should be performed before the time when the voltage amplitude of the bit line BL reaches the upper limit (time tsense1 in FIG. 10). Thus, there is a limitation in time. Since the difference in voltage change amount between adjacent linear lines is small before the time tsense1 as shown in FIG. 10, an erroneous detection may occur. On the other hand, since the change in voltage level of the bit line BL is small in the second linear line group 5, the voltage amplitude of the voltage level of the bit line does not reach the upper limit even at the time tsense2, which is later than the time tsense1. Therefore, if the voltage of the bit line is detected at the time tsense2, the time difference in voltage change amount between two bit lines for which the values of currents flowing therethrough differ by one level becomes great, and the difference between the two bit lines may be detected without causing an error.

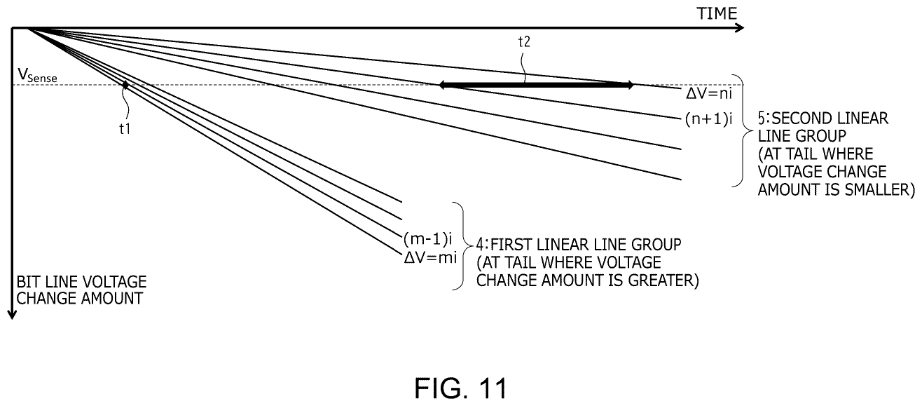

FIG. 11 shows the time difference for detecting the similarity between the first vector K and the second vector Q using the first linear line group 4 or the second linear line group 5. The horizontal axis in FIG. 11 represents time, and the vertical axis represents voltage change amount of the bit line BL. FIG. 11 shows an example in which the similarity is detected when the bit line BL has a predetermined voltage Vsense. If the first linear line group 4 is used, the time difference between the timing at which the voltage of the bit line BL through which the largest current flows reaches the predetermined voltage Vsense and the timing when the voltage of the bit line BL through which the second largest current flows reaches the predetermined voltage Vsense is t1, whereas if the second linear line group 5 is used, the time difference between the timing when the bit line BL through which the smallest current flows reaches the predetermined voltage Vsense and the timing when the bit line BL through which the second smallest current flows reaches the predetermined voltage Vsense is t2. Since the time difference t1 is far shorter than the time difference t2, an erroneous detection is likely to happen.

As described above, if the similarity between the first vector K and the second vector Q is detected based on the inner product value of the first vector K and the second vector Q, the similarity may be detected more accurately in the case where the inner product value is the smallest or near the smallest than the case where the inner product value is the largest or near the largest.

However, the greater the inner product value of the first vector K and second vector Q, the more the similarity is. Therefore, in order to detect vectors with high similarity, the detection may need to be performed for the case where the inner product is the largest or near the largest. The embodiment has a characteristic in that the state of high similarity between the first vector K and the second vector Q may be detected in the case where the inner product value of the first vector K and the second vector Q is the smallest or near the smallest.

In the embodiment, the first vector K (k0, k1, . . . , km) is substituted by a third vector L (n−k0, n−k1, . . . , n−km), where “n” is an arbitrary fixed value (“reference value”) that is equal to or more than the largest element of the first vector K. Therefore, each element of the third vector L is equal to or greater than zero.

The inner product value of the third vector L and the second vector Q (q0, q1, . . . , qm) may be expressed by the following equation (7):

$$\vec{L} \cdot \vec{Q} = n {\sum }_{i = 0}^{m} {q}_{i} - {\sum }_{i = 0}^{m} {k}_{i} {q}_{i} \qquad ( 7 )$$

In the equation (7), the second term on the right side indicates the calculation of the inner product of the first vector K and the second vector Q. The first term on the right side of the equation (7) means the sum of the elements of the second vector Q multiplied by “n.” Since the sign of the second term on the right side of the equation (7) is negative, the detection of the similarity between the first vector K and the second vector Q using the calculation result of the equation (7) is equivalent to the detection of the similarity near the lowest value of the calculation result of the equation (7).

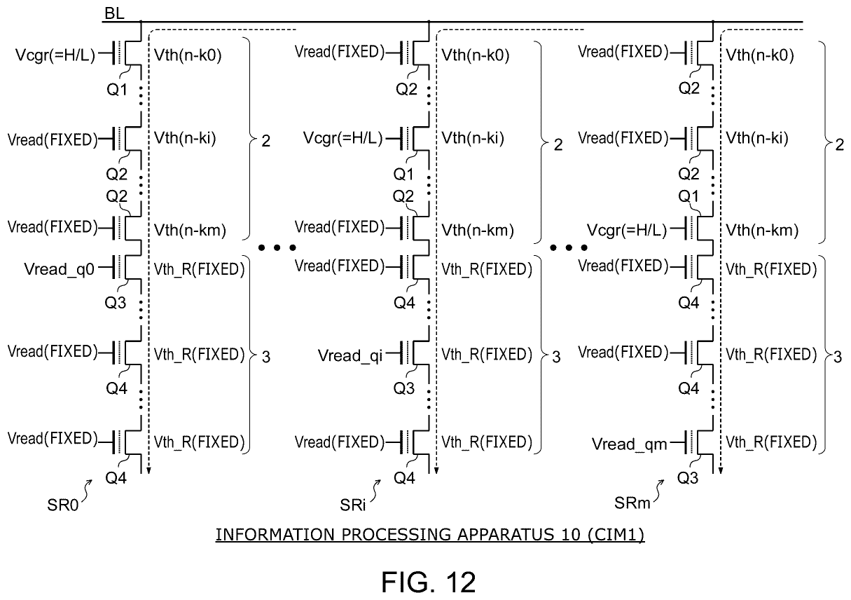

FIG. 12 is a circuit diagram of an information processing apparatus 10 according to an embodiment. The information processing apparatus 10 shown in FIG. 12 includes a CIM 1 that detects the similarity based on the equation (7). In FIG. 12, the elements common to those in FIG. 2 have the same reference symbols. Differences between FIGS. 2 and 12 will be mainly described below.

Like the CIM 1 shown in FIG. 2, the information processing apparatus 10 shown in FIG. 12 includes a plurality of strings SR0 to SRm, each having one end connected to the bit line. Each string has a first transistor group 2 and a second transistor group 3 connected in series. The second transistor group 3 shown in FIG. 12 is the same as the second transistor group 3 shown in FIG. 2, but the first transistor group 2 shown in FIG. 12 is different from the first transistor group 2 shown in FIG. 2.

More specifically, the threshold voltage set at each transistor of the first transistor group 2 in each string in FIG. 12 is different from that in FIG. 2. The threshold voltage set at each transistor of the first transistor group 2 corresponds to a value obtained by subtracting the corresponding element of the first vector K from the reference value “n.” The calculation to subtract the corresponding element of the first vector K from the reference value “n” may be performed by combining an operation to invert the bit string of each element of the first vector K and an operation to add the corresponding bit string to the reference value “n,” for example.

A current depending on the product of an element of the first vector K and a corresponding element of the second vector Q flows through each string. A current corresponding to the sum of currents flowing through the strings SR0 to SRm flows through the bit line BL. As the similarity between the first vector K and the second vector Q is higher, the current flowing through the bit line BL is lower. Therefore, the voltage amplitude indicating that the change in voltage of the bit line BL decreases as the similarity between the first vector K and the second vector Q becomes higher. Thus, the similarity between the first vector K and the second vector Q may be accurately detected by performing the similarity detection in the case where the voltage change amount of the bit line BL is the lowest or near the lowest.

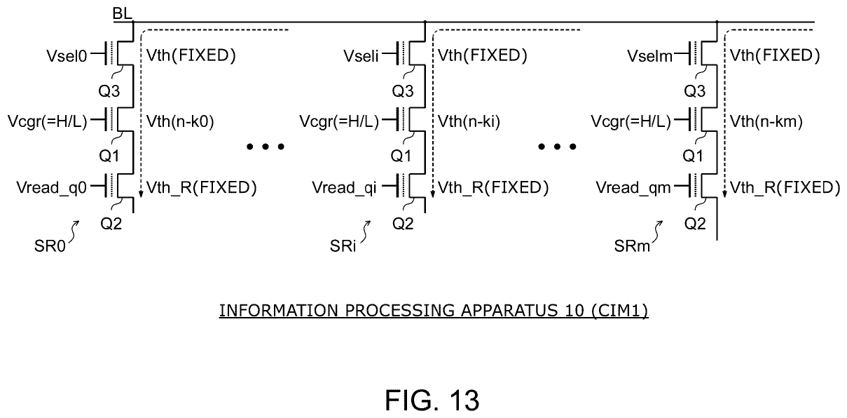

FIG. 13 is a circuit diagram of an information processing apparatus 10a according to a modification of the embodiment. The information processing apparatus 10a shown in FIG. 13 includes a CIM 1b that detects similarity based on the equation (7). The information processing apparatus 10a according to the modification has a circuit configuration obtained by simplifying the information processing apparatus 10 shown in FIG. 12. Each of strings SR0 to SRm of the information processing apparatus 10a according to the modification includes first to third transistors Q1 to Q3 that are connected in series. A threshold voltage Vth(n−k0), Vth(n−ki), . . . , or Vth(n−km) is set at each first transistor Q1. Except for this, the configuration is the same as that shown in FIG. 7.

As described above, the information processing apparatus 10a according to the modification calculates the inner product of the second vector Q and the third vector L. In more detail, a current depending on the product of corresponding elements of the second vector Q and the third vector L flows through each of the strings SR0 to SRm of the information processing apparatus 10a according to the modification. A current corresponding to the sum of the currents flowing through the strings SR0 to SRm flow through the bit line, and the potential of the bit line is determined according to the sum of the currents. The respective elements of the third vector L are obtained by subtracting the respective elements of the first vector K from the reference value “n.” Therefore, as the similarity between the first vector K and the second vector Q is higher, the inner product value of the second vector Q and the third vector L is lower.

The similarity between the first vector K and the second vector Q may be accurately detected by performing the similarity detection in the case where the voltage change amount of the bit line BL is the lowest or near the lowest using the information processing apparatus 10a according to the modification.

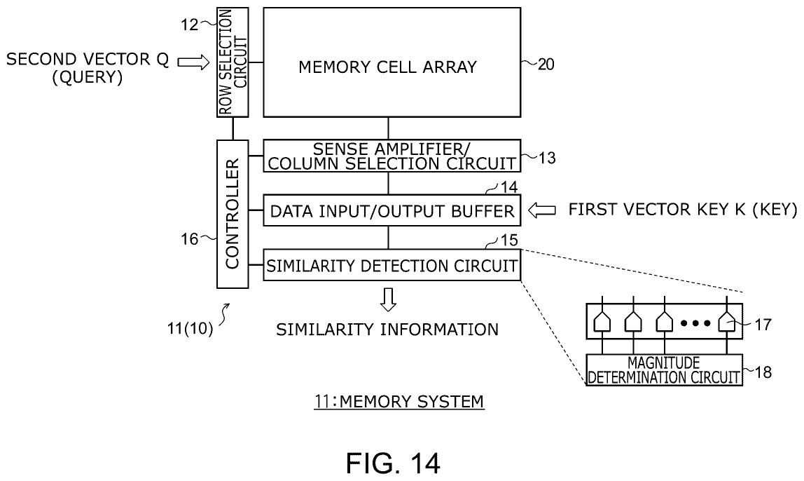

FIG. 14 is a block diagram showing a schematic configuration of a memory system 11 according to an embodiment, including the information processing apparatus 10 (CIM 1) shown in FIG. 12.

As shown in FIG. 14, the memory system 11 according to the embodiment includes a memory cell array 11, a row selection circuit 12, a sense amplifier/column selection circuit 13, a data input/output buffer 14, a similarity detection circuit 15, and a controller 16.

The memory cell array 11 includes one or more bit lines BL and a plurality of strings SR0 to SRm, an end of each of which is connected to a corresponding bit line BL, like the cases shown in FIGS. 12 and 13. Each string has a first transistor group 2 and a second transistor group 3 connected in series, like the cases shown in FIGS. 12 and 13.

The row selection circuit 12 receives an instruction from the controller 16 to control the gate voltage of each transistor included in the first transistor group 2 and the second transistor group 3 in each string. More specifically, the row selection circuit 12 supplies externally-inputted data (query) of the second vector Q to the gate of each transistor in each string. Since a different gate voltage is applied to each of the transistors in the same row of the strings, the gates of the transistors in the same row are not connected to a common word line. A plurality of word lines are therefore provided, each corresponding to one of the strings.

The sense amplifier/column selection circuit 13 senses the voltage of each bit line BL. If there are a plurality of bit lines BL, the sense amplifier/column selection circuit 13 may either sequentially select the voltages of the bit lines BL and serially output the result, or select and output the voltages of the bit lines BL in parallel.

The data input/output buffer 14 supplies a signal sensed by the sense amplifier/column selection circuit 13 to the similarity detection circuit 15, and also supplies externally-inputted data (key) including the first vector K to the sense amplifier/column selection circuit 13.

The similarity detection circuit 15 detects the similarity between the first vector K and the second vector Q based on the signal sensed by the sense amplifier/column selection circuit 13. More specifically, the similarity detection circuit 15 includes a plurality of analog-to-digital converters (“ADCs”) 17 and a magnitude determination circuit 18. The ADCs 17 convert output signals from the sense amplifier/column selection circuit 13 having sensed two or more bit lines BL to digital signals. Based on the digital signals, the magnitude determination circuit 18 determines whether the voltage of each bit line BL reaches a reference voltage Vsense. The similarity detection circuit 15 outputs similarity information of the first vector K and the second vector Q based on the determination result of the magnitude determination circuit 18. More specifically, the similarity detection circuit 15 detects that the similarity between the first vector K and the second vector Q is the highest when the inner product value thereof is calculated for the bit line BL for which the voltage reaches the reference voltage Vsense the latest.

As described above, in the embodiment, when the inner product of the first vector K and the second vector Q is calculated, the third vector L is newly prepared by subtracting the respective elements of the first vector K from the reference value “n,” and the inner product of the third vector L and the second vector Q is calculated. The calculation of the inner product is performed by using, for example, a plurality of strings SR0 to SRm, one end of each of which is connected to a single bit line BL. When the inner product of the first vector K and the second vector Q is calculated, as the similarity between the first vector K and the second vector Q is higher, the inner product value increases, the current flowing through the bit line BL increases, and the voltage change amount of the bit line BL increases. On the other hand, when the inner product of the third vector L and the second vector Q is calculated, as the similarity between the third vector L and the second vector Q is higher, the inner product value decreases, the current flowing through the bit line BL decreases, and the voltage change amount of the bit line BL decreases. Thus, the first vector K and the second vector Q having the highest similarity may be accurately detected by the similarity detection circuit 15 shown in FIG. 14 when the bit line BL for which the voltage change amount is the smallest is detected.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An information processing apparatus configured to detect similarity between a first vector having a plurality of elements and a second vector having a plurality of elements based on an inner product value of the first vector and the second vector, the information processing apparatus comprising:
a wiring line that carries a sum of currents each corresponding to a product of a value obtained by subtracting one of the elements of the first vector from a reference value and a corresponding one of the elements of the second vector;
a sense amplifier configured to sense a voltage on the wiring line; and
a similarity detection circuit configured to detect the similarity based on an output signal of the sense amplifier.

2. The information processing apparatus according to claim 1, wherein the similarity detection circuit detects that the similarity between the first vector and the second vector is higher as the inner product value is greater.

3. The information processing apparatus according to claim 1, wherein as the similarity between the first vector and the second vector is higher, the current flowing through the wiring line decreases.

4. The information processing apparatus according to claim 3, wherein as the current flowing through the wiring line decreases, a voltage change amount of the wiring line decreases.

5. The information processing apparatus according to claim 1, wherein the similarity detection circuit detects the similarity based on time needed for the output signal of the sense amplifier to reach a predetermined voltage level.

6. The information processing apparatus according to claim 1, wherein the value obtained by subtracting one of the elements of the first vector from the reference value is equal to or greater than zero.

7. The information processing apparatus according to claim 1, wherein the elements of the first vector are expressed as (k0, k1, . . . , km), the elements of the second vector are expressed as (q0, q1, . . . , qm), the reference value is denoted by “n,” and the current flowing through the wiring line is proportional to a value of an expression (1) provided below:
$$n {\sum }_{i = 0}^{m} {q}_{i} - {\sum }_{i = 0}^{m} {k}_{i} {q}_{i} \qquad ( 1 )$$

8. The information processing apparatus according to claim 1, further comprising a plurality of strings, one end of each of the strings being connected to the wiring line,
wherein a current flows through each of the strings, the current depending on a product of a value obtained by subtracting one of the elements of the first vector from the reference value and a corresponding one of the elements of the second vector,
wherein the current flowing through the wiring line is a sum of currents flowing through the strings.

9. The information processing apparatus according to claim 8, wherein each of the string includes:
a first transistor having a threshold voltage depending on the value obtained by subtracting the one of the elements of the first vector from the reference value; and
a second transistor that carries a current depending on the corresponding one of the elements of the second vector.

10. The information processing apparatus according to claim 9, wherein a first voltage is applied to a gate of the first transistor, and a current flows through the first transistor, the current depending on a voltage difference between the threshold voltage of the first transistor and the first voltage.

11. The information processing apparatus according to claim 10, wherein the current of the first transistor becomes greater as the voltage difference between the threshold voltage of the first transistor and the first voltage increases.

12. The information processing apparatus according to claim 9,
wherein the second transistor of each of the strings has a drain-source resistance value depending on the corresponding one of the elements of the second vector,
wherein a current flows through one of the elements, the current depending on a product of the one of the elements of the first vector and the corresponding one of the elements of the second vector.

13. The information processing apparatus according to claim 9, wherein the string includes:
a first transistor group including two or more transistors including the first transistor connected to each other; and
a second transistor group including one or more transistors including the second transistor, the second transistor group being disposed on a side that is more distant from the wiring line than the first transistor group.

14. The information processing apparatus according to claim 13, wherein a first voltage is applied to a gate of one transistor of the first transistor group, and a second voltage that is higher than the first voltage is applied to remaining transistors of the first transistor group.

15. The information processing apparatus according to claim 14,
wherein the first transistor group carries a current depending on a voltage difference between a threshold voltage of the one transistor to which the first voltage is applied, and the first voltage,
wherein the current of the first transistor group becomes greater as the voltage difference between the threshold voltage of the one transistor to which the first voltage is applied and the first voltage increases.

16. The information processing apparatus according to claim 14,
wherein the first transistor group includes (m+1) transistors including m transistors that are connected in series, where m is an integer of 1 or more, the m transistor including the first transistor,
wherein each of the (m+1) transistors has a threshold voltage depending on a corresponding one of (m+1) elements of the first vector.

17. The information processing apparatus according to claim 16, wherein the first voltage is applied to a gate of one of the (m+1) transistors, and remaining m transistors are set to be in an ON state.

18. The information processing apparatus according to claim 13,
the second transistor group includes (m+1) transistors connected in series, the (m+1) transistors including the second transistor, where m is an integer of 1 or more,
wherein a voltage depending on a corresponding one of (m+1) elements of the second vector is applied to a gate of one of the (m+1) transistors, and remaining m transistors of the second transistor group are set to be in an ON state.

19. The information processing apparatus according to claim 9,
wherein the first transistor and the second transistor are connected in series in each of the strings,
wherein a gate voltage depending on the corresponding one of the elements of the second vector is applied to a gate of the second transistor of each of the strings.

20. A memory system configured to detect similarity between a first vector having a plurality of elements and a second vector having a plurality of elements based on an inner product value of the first vector and the second vector, the memory system including:
a nonvolatile memory including a wiring line that carries a sum of currents each corresponding to a product of a value obtained by subtracting one of the elements of the first vector from a reference value and a corresponding one of the elements of the second vector;
a sense amplifier configured to sense a voltage on the wiring line; and
a similarity detection circuit configured to detect the similarity based on an output signal of the sense amplifier.
